(19) United States
(12) Patent Application Publication
(10) Pub. No.: US 2008/0204402 A1
(43) Pub. Date: Aug. 28, 2008

(54) USER INTERFACE DEVICE

(76) Inventors: Yoichi Hirata, Kanagawa (JP); Masanobu Shibuya, Kanagawa (JP); Masato Nagura, Shizuoka (JP); Makoto Ito, Saitama (JP)

Correspondence Address: Frank Pincelli;Patent Legal Staff, Eastman Kodak Company, 343 State Street, Rochester, NY, 14650-2201, US

(21) Appl. No.: 11/763,493

(22) Filed: Jun. 15, 2007

(30) Foreign Application Priority Data
Feb. 22, 2007 (JP) 2007-042984

(51) Int. Cl. G09G 5/00

(52) U.S. Cl. 345/156

(57) ABSTRACT

A UI device of a digital camera has a display screen, a left-side touch strip provided outside of and on a left side of the display screen and a right-side touch strip provided outside of and on a right side of the display screen. The touch strips 22 and 24 can distinguishably detect a slide operation in a vertical direction by the user and a slide operation in a horizontal direction by the user. When a slide operation in the vertical direction is detected, a controller of the UI device recognizes the operation as a manipulative instruction in which the amount of movement is considered important, such as an operation for selection of items or scrolling of a screen. When a slide operation in the horizontal direction is detected, the controller recognizes the slide operation as a triggering manipulative instruction in which the amount of movement is not as important, such as a file deletion instruction or display or non-display of a new hierarchical item.

### CROSS REFERENCE TO RELATED APPLICATIONS

This application claims priority to Japanese Patent Application No. 2007-042984 filed on Feb. 22, 2007, which is incorporated herein by reference in its entirety.

### FIELD OF THE INVENTION

The present invention relates to a user interface device equipped in a portable electronic device which receives an instruction from a user and presents information to a user.

### BACKGROUND OF THE INVENTION

Various types of portable electronic devices, such as digital cameras and game machines, are widely used and required to be compact enough to improve their portability. On the other hand, a large screen is preferable to display information and data. To satisfy these requirements, the portable electronic devices cannot provide a sufficient space for operation elements (e.g., manipulation buttons).

A large number of operation elements for manipulation or setting are required to realize multiple functions or highly advanced functions of the portable electronic devices. However, as described above, many of the portable electronic devices cannot provide a sufficient space for the operation elements. In this respect, some technique capable of manipulating an electronic device with a smaller number of operation elements is required.

For example, there is a conventional technique that allocates two or more functions to a single manipulation button and enables a user to selectively switch the function of the manipulation button based on pushing time or the number of pushing actions (i.e., the number of click actions) applied to the manipulation button. However, according to this conventional technique, a user may perform an erroneous operation because of complexity of the manipulation on an operation element.

A slide detector is an operation element capable of detecting a user's finger action or a slide movement of a pen-like member. However, the capability of a conventional slide detector is limited to detection of direction, orientation, and distance, such as scrolling of a screen or shifting of a cursor. Therefore, the conventional slide detector cannot contribute to reduction in the total number of operation elements, although the number of direction buttons may be reduced. As a result, using a slide detector is not effective in reducing the size of a portable electronic device.

A conventional technique discussed in Japanese Patent Application Laid-open No. 2006-129942 enables a user to change processing contents according to the direction of a slide manipulation. More specifically, according to a baseball game discussed in Japanese Patent Application Laid-open No. 2006-129942, a user can change a standing position of a pitcher by performing a horizontal slide manipulation in a predetermined area AR1 on a game screen. The pitcher starts a windup motion in response to a vertical slide manipulation by a user that crosses a gate line G1 (i.e., a border line between the area AR1 and a neighboring area AR2).

According to the above-described conventional technique, two different processing contents (i.e., position change of a pitcher and start of a windup motion) can be realized by a user who performs similar slide manipulations. In other words, this conventional technique can reduce a total number of operation elements because an operation element dedicated to a position change instruction and an operation element dedicated to a windup start instruction are not separately required.

However, according to the technique discussed in Japanese Patent Application Laid-open No. 2006-129942, the horizontal slide manipulation detection area AR1 is slightly different or offset from the vertical slide manipulation detection area (i.e., an area straddling the line G1). A relatively large space is required to provide the horizontal slide manipulation detection area and the vertical slide manipulation detection area.

In short, none one of the above-described conventional techniques can reduce the size of a portable electronic device without deteriorating the operability of a portable electronic device.

### SUMMARY OF THE INVENTION

The present invention is directed to a user interface device which can be easily operated by a user and can reduce the size of a portable electronic device.

An aspect of the present invention provides a user interface device equipped in a portable electronic device, which receives an instruction from a user and which presents information to a user. The user interface device according to the present invention includes: a display screen; a slide detection unit which detects slide operation applied by a user and which distinguishably detects a slide operation to a predetermined first direction and a slide operation to a second direction which is approximately perpendicular to the first direction; and a controller which changes a content to be displayed on the display screen according to a slide operation detected by the slide detection unit. The controller recognizes a slide operation in the first direction detected by the slide detection unit as a vector instruction in which the amount of movement of the slide operation is heavily weighted, and recognizes a slide operation in the second direction as a triggering instruction in which the amount of movement of the slide operation is not heavily weighted.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1 is a schematic block diagram illustrating a digital camera according to an embodiment of the present invention;

FIG. 2 illustrates a back surface of the digital camera illustrated in FIG. 1;

FIG. 3 illustrates an exemplary manipulation performed by a user for the digital camera illustrated in FIG. 1;

FIG. 4 illustrates an exemplary menu setting screen displayed on a display screen of the digital camera illustrated in FIG. 1;

FIG. 5 illustrates an exemplary setting of an item having a three-layer hierarchical structure;

FIG. 6 illustrates an exemplary image selection screen displayed on the display screen of the digital camera;

FIG. 7 illustrates an exemplary switching between the image selection screen and a full-screen display of a selected image;

FIG. 8 illustrates an exemplary display of a full-screen image;

FIG. 9 illustrates an exemplary display of a full-screen image;

FIG. 10 illustrates an exemplary display of an image and a setting screen in an image setting mode;

FIG. 11 illustrates an exemplary deletion of a recorded image;

FIG. 12 illustrates an exemplary image selection based on input of a shooting date; and

FIG. 13 illustrates an exemplary character string input operation.

### DESCRIPTION OF PREFERRED EMBODIMENTS

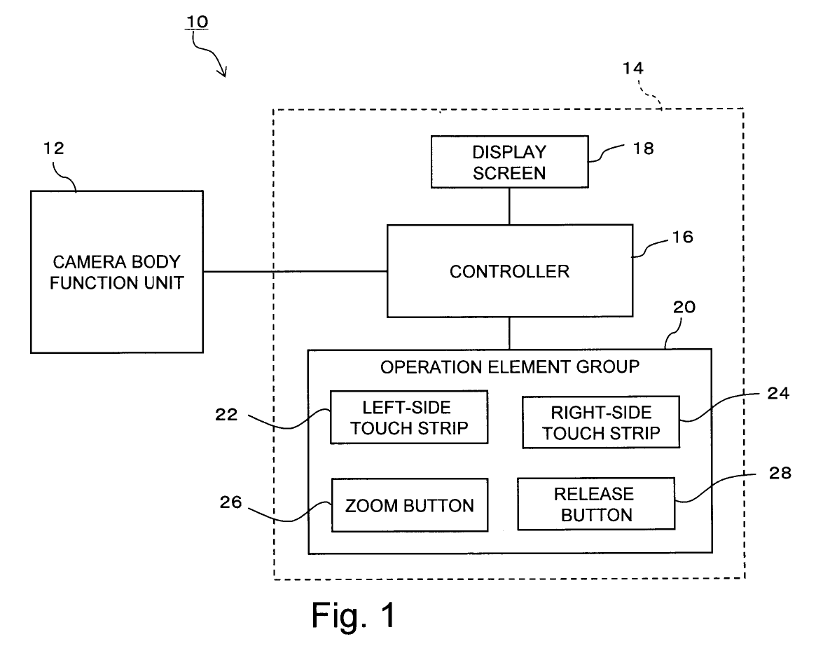

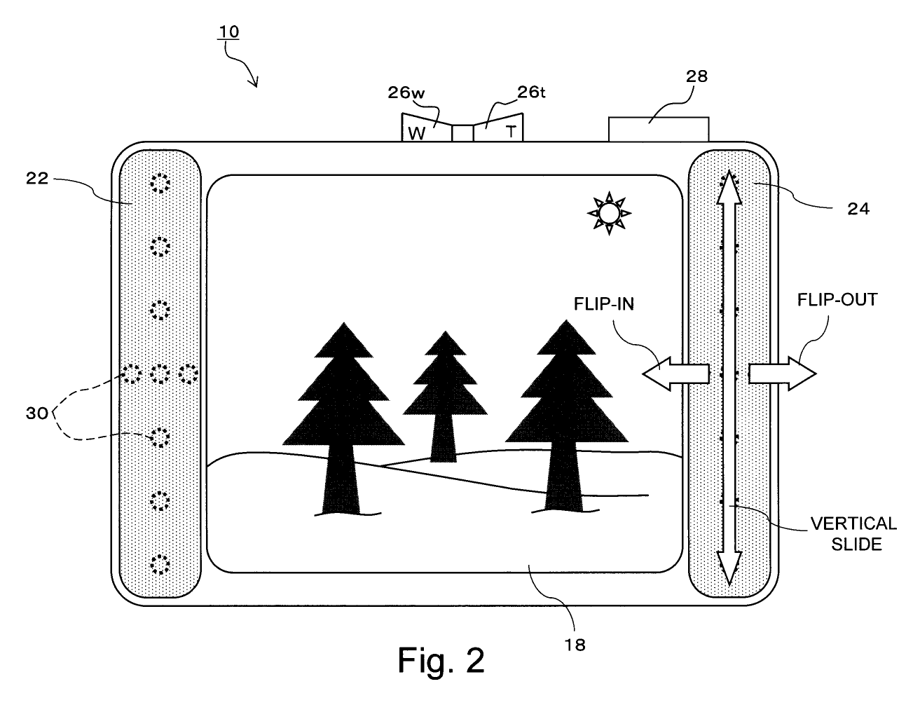

Exemplary embodiments of the present invention will be described in detail below with reference to the drawings. FIG. 1 is a schematic block diagram illustrating a digital camera 10 according to an embodiment of the present invention. FIG. 2 illustrates a back surface of the digital camera 10.

The digital camera 10 includes a camera body function unit 12 and a user interface device (hereinafter, referred to as “UI device”) 14. The camera body function unit 12 performs fundamental functions of a camera, such as image pickup processing and image storage processing. Accordingly, the camera body function unit 12 includes an imaging lens, an image pickup element, an image processing circuit, and a memory, whose detailed structures are well known in the prior art.

The UI device 14 receives a manipulative instruction applied by a user and provides information to a user. The UI device 14 includes a controller 16, a display screen 18, and an operation element group 20. The controller 16 controls the entire operation of the UI device 14, based on manipulative instructions entered by a user through the operation element group 20 or based on information or data obtained from the camera body function unit 12.

The controller 16 can be an independent unit separated from the camera body function unit 12 or can be a controller provided in the camera body function unit 12.

The display screen 18 including a display device (e.g., a liquid crystal display (LCD)) is provided on a back surface of the digital camera 10 as illustrated in FIG. 2. The display screen 18 occupies almost the entire area of the back surface of the digital camera 10 so that an image can be displayed largely with a higher resolution. The display screen 18 can display a recorded image, a preview image which is occasionally obtained, and a later-described menu setting screen in response to an instruction of a user.

The operation element group 20 includes a plurality of operation elements, such as a release button 28 and a zoom button 26, which enable a user to input a manipulative instruction. The release button 28 is a push button that enables a user to input an image-pickup or photographing instruction and is provided on the right side of an upper surface of the digital camera 10. If a user pushes the release button 28 for a shooting operation, the camera 10 starts image pickup processing according to a predetermined procedure.

The zoom button 26, which enables a user to input an imaging magnification instruction, is disposed next to the release button 28 on the upper surface of the digital camera 10. The zoom button 26 includes a TELE switch 26t and a WIDE switch 26w. The TELE switch 26t enables a user to change the imaging magnification toward a telephoto magnification, while the WIDE switch 26w enables a user to change the imaging magnification toward a wide-angle magnification.

If a user presses the TELE switch 26t or the WIDE switch 26w, the controller 16 transmits the type of switch that has been pressed together with a pressing time to the camera body function unit 12. The camera body function unit 12 changes the imaging magnification based on the information received from the controller 16. Furthermore, the zoom button 26 enables a user to change a display magnification in a playback operation of a recorded image.

Furthermore, the operation element group 20 includes two touch strips, i.e., a left-side touch strip 22 and a right-side touch strip 24, which can function as operation elements in the present embodiment. The left-side touch strip 22 is disposed on the left side of the display screen 18 and the right-side touch strip 24 is disposed on the right side of the display screen 18.

The touch strips 22 and 24 can detect a touch operation, a push (or tap) operation, and a slide operation performed by a user with a finger. A user can manipulate the touch strips 22 and 24 for menu settings and playback of recorded images, as will be described later.

The touch strips 22 and 24 have an elongated rectangular shape extending in the vertical direction. The touch strips 22 and 24 have a flat surface and include a plurality of pressure sensors 30 embedded beneath the flat surface. More specifically, as illustrated in FIG. 2 a total of seven pressure sensors 30 are aligned along a longitudinal direction, while three pressure sensors 30 are aligned along a transverse direction. In other words, a group of pressure sensors 30 aligned in the transverse direction intersect a group of pressure sensors 30 aligned in the longitudinal direction.

The touch strips 22 and 24 can distinguishably detect a touch operation by a user as well as a push operation by a user based on a pressing force detected by the pressure sensors 30. Furthermore, the touch strips 22 and 24 can obtain various information or data, e.g., direction, orientation, speed, and distance, relating to a slide operation based on a change in the touch position of a finger which can be detected by the pressure sensors 30.

In other words, the present embodiment provides the touch strips 22 and 24 which can distinguishably detect different kinds of operations (e.g., push, touch, and slide). As described later, the digital camera 10 (the UI device 14) can allocate a function differentiated depending on the type of a manipulation and, even if a user manipulates the same touch strip (22 or 24) at the same timing, the digital camera 10 can execute processing differentiated depending on the content of a manipulation (i.e., push operation, touch operation, or slide operation).

As a result, the user interface device according to the present embodiment enables a user to perform various manipulations with a smaller number of operation elements. The present embodiment can reduce a space required for the operation elements.

Furthermore, as already described, the present embodiment provides the pressure sensors 30 which are disposed in both longitudinal and transverse directions on the touch strips 22 and 24. Each touch strip 22 or 24 can detect a slide operation in the longitudinal direction and a slide operation in the transverse direction. As a result, the present embodiment does not require any operation element dedicated to the detection of a slide operation in the longitudinal direction and any operation element dedicated to the detection of a slide operation in the transverse direction. The present embodiment can therefore reduce a space required for the operation elements.

As described later, the present embodiment provides the controller 16 which can discriminate the instruction content of each slide operation based on the direction of a slide operation. More specifically, the controller 16 recognizes a longitudinal slide operation on the touch strips 22 and 24 as a vector instruction, such as an item selection position instruction, a shift instruction, a display screen scroll instruction, and an up/down instruction of a numerical value and date.

Furthermore, the controller 16 recognizes a transverse slide operation on the touch strips 22 and 24 as a triggering instruction for executing any processing, such as a mode switching instruction, a file deletion instruction, a new hierarchical item display/non-display instruction.

In the following description, to explicitly define the differences of slide operations, a slide operation in the longitudinal direction is referred to as “vertical slide” operation. Furthermore, a slide operation in the transverse direction is referred to as a “flip-in” operation if the orientation of the slide operation is directed toward the display screen 18 and is referred to as “flip-out” operation if the orientation of the slide operation is opposite to the “flip-in” operation.

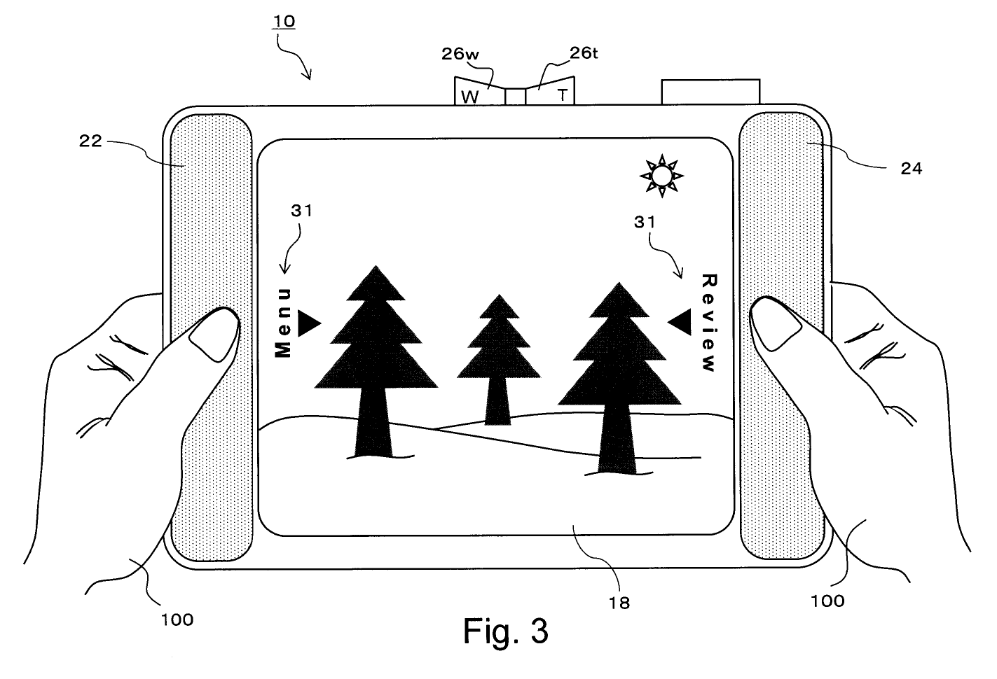

A user can perform menu settings and playback of recorded images with the UI device 14 of the digital camera 10 as illustrated in FIG. 3. When a user performs menu settings or playback of recorded images, the user holds right and left edges of the digital camera body with both hands 100. The default mode of the digital camera 10 is a preview mode according to which a preview image is displayed on the display screen 18.

The user interface device according to the present embodiment enables a user to switch the operation mode with a finger (i.e., thumb) of the hand 100 holding the camera body. If a user performs a flip-in operation on the left-side touch strip 22, the controller 16 switches the operation mode from the preview mode (default mode) to a menu setting mode. If a user performs a flip-in operation on the right-side touch strip 24, the controller 16 switches the operation mode from the preview mode to a review mode that performs playback of a recorded image. In this case, the controller 16 displays a guide 31 on the display screen 18 when a user touches the touch strips 22 and 24 with a finger.

More specifically, when a user touches the touch strips 22 and 24 with a finger, the controller 16 displays a character string “Menu” together with an arrow directed inward (i.e., rightward) on the left side of the display screen 18. If a user performs a rightward slide operation (i.e., a flip-in operation) on the left-side touch strip 22, the controller 16 switches the operation mode to the menu setting mode.

Furthermore, the controller 16 displays a character string “Review” together with an arrow being directed inward (i.e., leftward) on the right side of the display screen 18. If a user performs a leftward slide operation (i.e., a flip-in operation) on the right-side touch strip 24, the controller 16 switches the operation mode to the review mode.

The display of the guide 31 is effective in reducing erroneous operations by the user. As will be apparent from the above description, even when a user manipulates the same touch strip (22 or 24) at the same timing, the controller 16 can recognize a touch operation on the touch strips 22 and 24 as an instruction for displaying the guide 31. Furthermore, the controller 16 recognizes a flip-in operation on the touch strips 22 and 24 as a mode switching instruction.

In this manner, the controller 16 can distinguishably detect different types of manipulations on the same touch strip and can differentiate the processing content depending on the type of manipulation. Thus, the user interface device according to the present embodiment enables a user to perform various manipulations with a smaller number of operation elements. The present embodiment can reduce a space required for the operation elements.

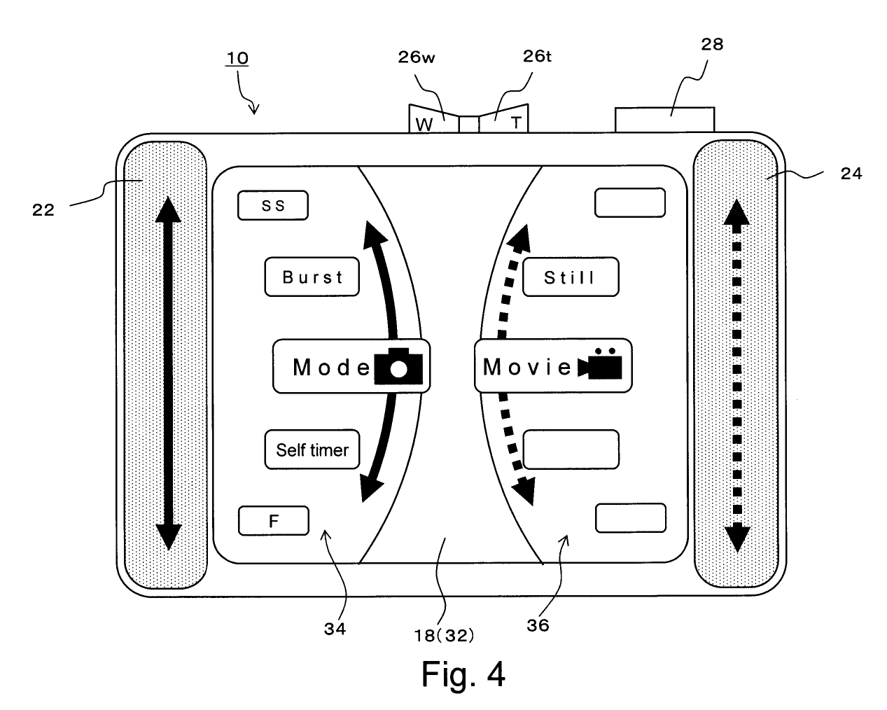

If a user wants to switch the operation mode from the state illustrated in FIG. 3 to the menu setting mode, the user can perform a flip-in operation on the left-side touch strip 22 as instructed by the guide 31. When the flip-in operation on the left-side touch strip 22 is detected, the controller 16 displays a menu setting screen on the display screen 18. FIG. 4 illustrates an exemplary menu setting screen 32 displayed on the display screen 18.

A user can set any one of a plurality of menu items displayed on the menu setting screen 32. The menu items stored and managed in the present embodiment are classified into a hierarchical structure. More specifically, the menu items include a plurality of upper hierarchical items 34 and a plurality of lower hierarchical items 36 which respectively correspond to the upper hierarchical items 34.

The upper hierarchical items 34 are names of various functions whose contents can be set by a user. For example, the upper hierarchical items 34 include a “(shooting) Mode” function, a “Burst” function, and a “Self-timer” function. The lower hierarchical items 36 are setting values for respective functions corresponding to the upper hierarchical items 34 which can be selected by a user.

For example, “Movie” indicates shooting of a moving image and “Still” indicates shooting of a still image, both of which are lower hierarchical items 36 corresponding to the “Mode” function. Furthermore, “5 sec” or “15 sec” indicates a shooting standby time and “off” indicates cancellation of the “Self-timer” function, both of which are lower hierarchical items 36 corresponding to the “Self-timer” function.

The hierarchical structure of the menu items is not limited to a two-layer hierarchical structure. For example, some of the menu items may have a three-layer hierarchical structure that includes an upper hierarchical item, an intermediate hierarchical item, and a lower hierarchical item.

A user can select a desired item from the displayed items, i.e., from the upper hierarchical items 34 and the lower hierarchical items 36 corresponding to respective upper hierarchical items 34 which are arranged in a two-layer hierarchical structure.

The controller 16 displays the upper hierarchical items 34 along an arc line on the left side of the display screen 18. The controller 16 displays a presently selected upper hierarchical item 34 at approximately the center, in height, among the plurality of upper hierarchical items 34 displayed on the screen 18. Furthermore, the controller 16 displays the presently selected upper hierarchical item 34 in a highlighted state so as to have a large size compared to other upper hierarchical items 34.

The controller 16 displays the lower hierarchical items 36 corresponding to the presently selected upper hierarchical item 34 on the right side of the display screen 18. According to the example illustrated in FIG. 4, the selected upper hierarchical item 34 is the “Mode” function. Therefore, the controller 16 displays “Movie” and “Still” on the right side of the screen 18, which are the lower hierarchical items 36 corresponding to the “Mode” function.

Similarly, the controller 16 displays the lower hierarchical items 36 along an arc line on the right side of the display screen 18. The controller 16 displays a presently selected lower hierarchical item 36 at approximately the center, in height. The controller 16 displays the presently selected lower hierarchical item 36 in a highlighted state so as to have a large size compared to other lower hierarchical items 36.

In the menu setting mode, a user can select a desired item by manipulating two touch strips 22 and 24. More specifically, if a vertical slide operation on the left-side touch strip 22 is detected, the controller 16 performs processing for scrolling a plurality of upper hierarchical items 34 displayed on the display screen 18 based on the orientation (upward or downward), distance, and speed of the vertical slide operation. Thus, the controller 16 enables a user to switch the position indicating a selected upper hierarchical item 34.

Then, the controller 16 successively switches the lower hierarchical items displayed on the right side of the display screen 18 according to the switching of the position indicating a selected upper hierarchical item 34. More specifically, if a user switches the upper hierarchical item 34 from “Mode” to “Self-timer”, the controller 16 automatically switches the lower hierarchical items 36 from a group of items relating to the “Mode” function to a group of items relating to the “Self-timer” function which are displayed on the right side of the display screen 18.

Furthermore, if a vertical slide operation on the right-side touch strip 24 is detected, the controller 16 performs processing for scrolling a plurality of lower hierarchical items 36 displayed on the display screen 18 based on the orientation, distance, and speed of the vertical slide operation. Thus, the controller 16 enables a user to switch the position indicating a selected lower hierarchical item 36.

Furthermore, if a push operation on the right-side touch strip 24 is detected, the controller 16 stores the setting content indicated by the presently selected lower hierarchical item 36 as a new setting content. At the same time, the controller 16 terminates the operation of the menu setting mode and returns the operation mode to the preview mode.

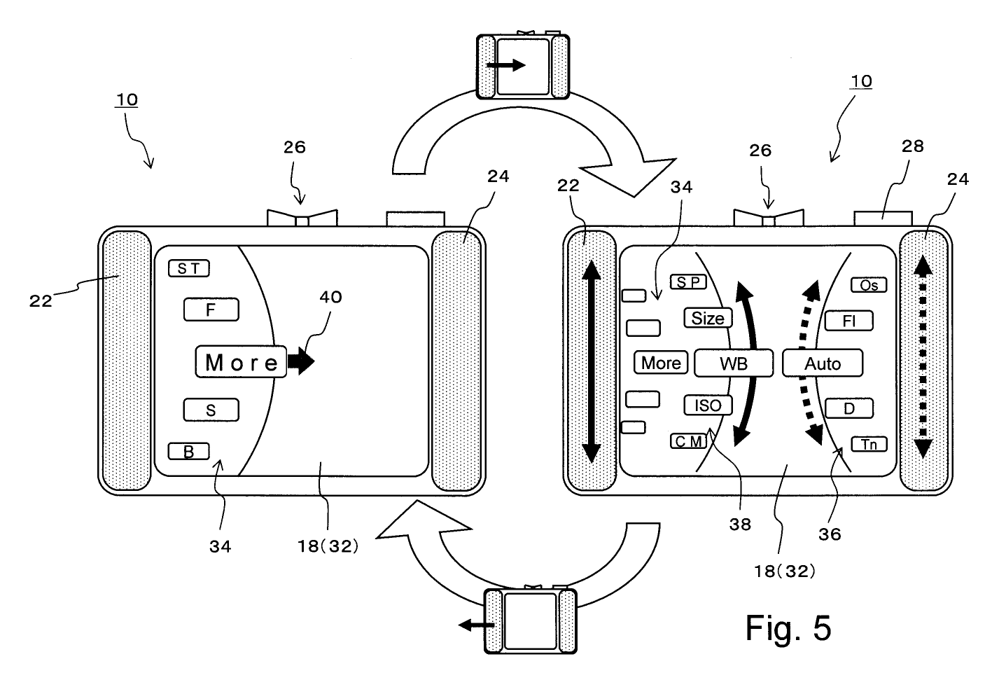

FIG. 5 illustrates an exemplary setting of a menu item having a three-layer hierarchical structure.

According to the example illustrated in FIG. 5, the “More” function (one of the upper hierarchical items 34) has a three-layer hierarchical structure. If a user selects the “More” function having a three-layer hierarchical structure, the controller 16 displays only the upper hierarchical items 34 on the menu setting screen 32, as illustrated on the left side of FIG. 5, without displaying any lower hierarchical items 36. In this state, if a user performs a flip-in operation on the left-side touch strip 22, the controller 16 displays intermediate hierarchical items 38 on the display screen 18 together with an arrow guide 40 directed inward from the highlighted upper hierarchical item 34 (i.e., “More”).

In the state where the upper hierarchical item 34 having a three-layer hierarchical structure (i.e., “More”) is selected (refer to the left side of FIG. 5), if a flip-in operation on the left-side touch strip 22 is detected, the controller 16 displays a plurality of intermediate hierarchical items 38 along an arc line slightly on the left side of the display screen 18. Meanwhile, the controller 16 reduces the image size of the displayed plurality of upper hierarchical items 34 and shifts the reduced images to the left side.

Furthermore, the controller 16 displays a plurality of lower hierarchical items 36 corresponding to the presently selected intermediate hierarchical item 38 along an arc line on the right side of the display screen 18. Furthermore, the controller 16 displays a presently selected item in a highlighted state so as to have a large size compared to other items.

After the intermediate hierarchical items 38 are displayed, a user can select a desired intermediate hierarchical item 38 and a lower hierarchical item 36 according to manipulation contents similar to the manipulation contents described with reference to FIG. 4. Namely, in the state where the intermediate hierarchical items 38 are displayed (i.e., an exemplary state illustrated on the right side of FIG. 5), if a finger of a user slides vertically on the left-side touch strip 22, the controller 16 scrolls the displayed intermediate hierarchical items 38 to successively switch the selected position. At the same time, the controller 16 successively switches the lower hierarchical items 36 in response to the switching of the position indicating a selected intermediate hierarchical item 38.

Furthermore, if a finger of a user slides vertically on the right-side touch strip 24, the controller 16 scrolls the displayed lower hierarchical items 36 so as to successively switch the selected position. Then, if a user pushes the right-side touch strip 24 when a desired item is selected, the controller 16 newly stores the setting content indicated by a presently selected lower hierarchical item 36 and returns the operation mode to the ordinary preview mode.

Furthermore, a user can perform a flip-out operation on the left-side touch strip 22 (i.e., a slide operation in a direction departing from the display screen 18) to return the display of the screen 18 from a state where the intermediate hierarchical items 38 are selectable (i.e., an exemplary state illustrated on the right side of FIG. 5) to a state where the upper hierarchical items 34 are selectable (i.e., an exemplary state illustrated on the left side of FIG. 5).

If a flip-out operation on the left-side touch strip 22 is detected, the controller 16 stops displaying the intermediate hierarchical items 38 and the lower hierarchical items 36. The controller 16 displays the upper hierarchical items 34 which are returned to the original size from the reduced size. A user can scroll the displayed upper hierarchical item 34 by sliding a finger vertically on the left-side touch strip 22. Furthermore, in a state where the upper hierarchical items 34 are selectable, if a user performs a flip-out operation on the left-side touch strip 22, the controller 16 terminates the operation of the menu setting mode and returns the operation mode to the preview mode.

As described above, in a state where the upper hierarchical item 34 having a three-layer hierarchical structure (i.e., “More”) is selected, if a user performs a flip-in operation on the left-side touch strip 22, the controller 16 displays the intermediate hierarchical items (i.e., new hierarchical items).

On the other hand, in the same state (i.e., in a state where the upper hierarchical item 34 having a three-layer hierarchical structure is selected), if a finger of a user slides vertically on the left-side touch strip 22 instead of performing a flip-in operation, the controller 16 successively switches the position indicating a selected upper hierarchical item 34 without displaying the intermediate hierarchical items 38 (refer to FIGS. 4 and 5).

Furthermore, in a state where the intermediate hierarchical items 38 are displayed, if a finger of a user slides vertically on the left-side touch strip 22, the controller 16 performs the processing for scrolling the intermediate hierarchical items 38. On the other hand, if a user performs a flip-out operation on the same touch strip (i.e., left-side touch strip 22), the controller 16 stops displaying the intermediate hierarchical items 38.

Namely, the digital camera 10 according to the present embodiment can execute processing differentiated according to a direction of a slide operation even if a user performs the slide operation on the same left-side touch strip 22 in the same situation. In other words, the present embodiment can allocate a plurality of functions to a single touch strip of the digital camera 10. As a result, the present embodiment can reduce the total number of operation elements and can reduce the size of the digital camera 10.

According to a conventional technique capable of allocating a plurality of functions to the same operation element to reduce the total number of operation elements, switching of the processing content is dependent on pushing time or the number of pushing actions applied to the operation element. A user's finger manipulation on the operation element does not change so much in position and movement. Therefore, a user cannot clearly recognize the content of a manipulation. A user may thus perform an erroneous manipulation.

On the other hand, the user interface device (UI device 14) according to the present embodiment enables a user to switch the processing content based on the direction of a slide operation. A user's finger action in a vertical slide operation is clearly different from a user's finger action in a horizontal slide (flip-in or flip-out) operation. Therefore, a user can clearly recognize the content of each manipulation. As a result, even if the total number of the operation elements is reduced, a user can reduce erroneous operations.

Furthermore, user's vertical and horizontal slide operations are performed in the same region (i.e., on the same touch strip). The touch strip is not required to have an excessively large operation area. Therefore, the present embodiment can reduce the size of the digital camera 10.

Furthermore, as will be apparent from the foregoing description, the user interface device according to the present embodiment recognizes a user's vertical slide operation as a manipulative instruction having vector-like meaning such as scrolling of items. In other words, when a finger of a user slides vertically, the user interface device detects the amount (e.g., distance) of a slide operation and the digital camera executes the processing based on the detected slide amount.

On the other hand, the user interface according to the present embodiment recognizes a user's horizontal slide operation as a manipulative instruction serving as a trigger to execute predetermined processing, such as a mode switching instruction and a new hierarchical item display instruction. In this case, the digital camera does not execute the processing based on the amount of slide.

In other words, the user interface according to the present embodiment can distinguishably recognize a manipulative instruction depending on the direction of a slide operation performed by a user. Therefore, a user can accurately discriminate the processing content based on the direction of a slide operation. As a result, a user can easily manipulate the operation elements.

Furthermore, the user interface according to the present embodiment enables a user to manipulate the left-side touch strip 22 to scroll the items displayed on the left side of the display screen 18, and enables a user to manipulate the right-side touch strip 24 to scroll the items displayed on the right side of the display screen 18. Therefore, a user can easily perceive the content of each manipulative instruction applied on the touch strips 22 and 24. As a result, a user can easily manipulate the operation elements.

A user can manipulate the UI device 14 in the review mode to perform playback of a recorded image. If a user wants to change the operation mode to the review mode, the user can perform a flip-in operation on the right-side touch strip 24 in a state where a preview image is displayed on the display screen 18 (i.e., the preview mode illustrated in FIG. 3) as described above.

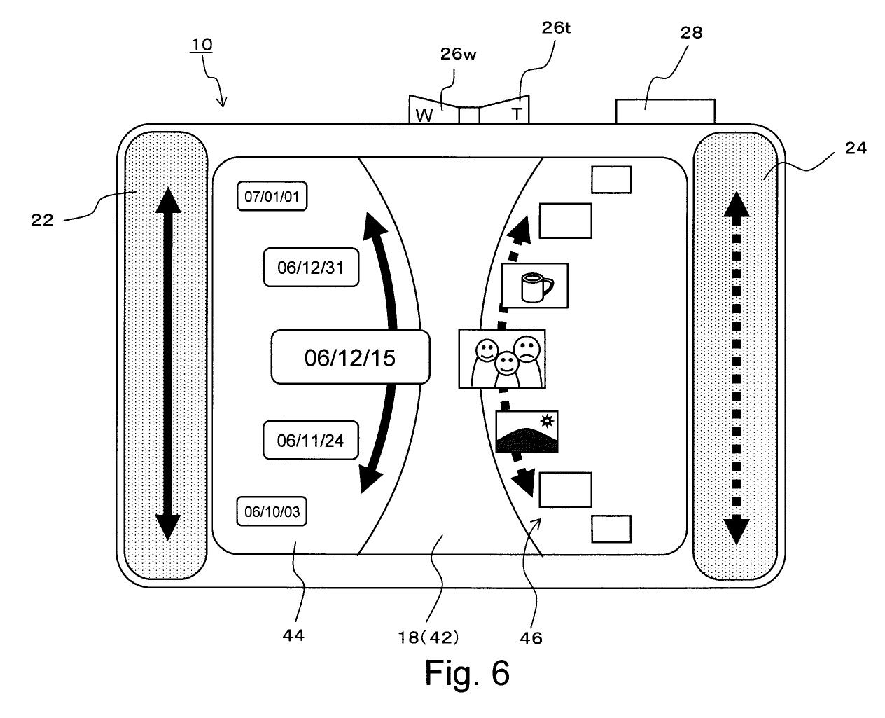

If a flip-in operation on the right-side touch strip 24 is detected, the controller 16 displays an image selection screen on the display screen 18. FIG. 6 illustrates an exemplary image selection screen 42 displayed on the display screen 18.

In the present embodiment, the digital camera 10 classifies recorded images based on a shooting date of each image and manages the recorded images based on the shooting date. Therefore, when the playback of a recorded image is necessary, a user designates a shooting date and selects a desired image from the recorded images belonging to the designated date. The relationship between the shooting date and the recorded image is similar to the relationship between the upper hierarchical item 34 and the lower hierarchical item 36 in the above-described menu setting mode. Accordingly, the method for selecting a playback image is similar to the method for selecting a menu item in the above-described menu setting mode.

More specifically, the controller 16 displays a plurality of shooting dates 44 on the image selection screen 42, which correspond to the upper hierarchical items disposed on the left side of the display screen 18. The controller 16 displays a presently selected shooting date 44 at approximately the center in height among the plurality of shooting dates 44 displayed on the screen 18. Furthermore, the controller 16 displays the presently selected shooting date 44 in a highlighted state so as to have a large size compared to other shooting dates 44.

Furthermore, the controller 16 displays a plurality of recorded images 46 (more specifically, thumbnail images of the recorded images 46) obtained on the presently selected shooting date 44 along an arc line on the right side of the display screen 18. The controller 16 displays a presently selected recorded image 46 at approximately the center, in height, among the plurality of recorded images 46 displayed on the screen 18. Furthermore, the controller 16 displays the presently selected recorded image 46 in a highlighted state so as to have a large size compared to other recorded images 46.

In this state, if a vertical slide operation on the left-side touch strip 22 is detected, the controller 16 scrolls the displayed shooting dates 44 according to the orientation, speed, and distance of the slide and successively switches the selected position. The controller 16 successively switches recorded images 46 displayed on the right side of the display screen 18 in response to the switching of the position indicating a selected shooting date 44. Furthermore, when a vertical slide operation on the right-side touch strip 24 is detected, the controller 16 scrolls the displayed recorded images 46 and successively switches the selected position according to the orientation, speed, and distance of the slide.

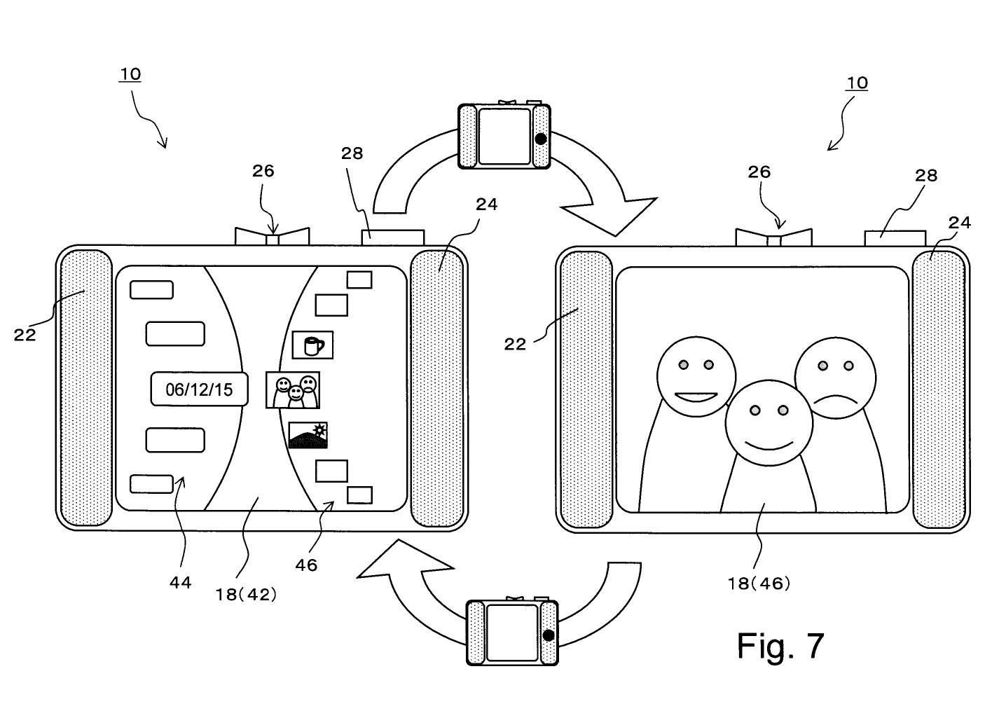

A user can push the right-side touch strip 24 to realize a full-screen display of the presently selected recorded image 46. FIG. 7 illustrates an exemplary switching between the image selection screen 42 and a full-screen display of a selected image. As illustrated in FIG. 7, in a state where a desired recorded image 46 is selected, if a push operation on the right-side touch strip 24 is detected, the controller 16 displays a full-screen image of the selected recorded image 46. Furthermore, in the full-screen display state, if a push operation on the right-side touch strip 24 is detected again, the controller 16 stops the full-screen display of the desired recorded image 46 and displays the image selection screen 42. Namely, the user interface device according to the present embodiment enables a user to switch the full-screen display of a selected image and the image selection screen by successively pushing the right-side touch strip 24.

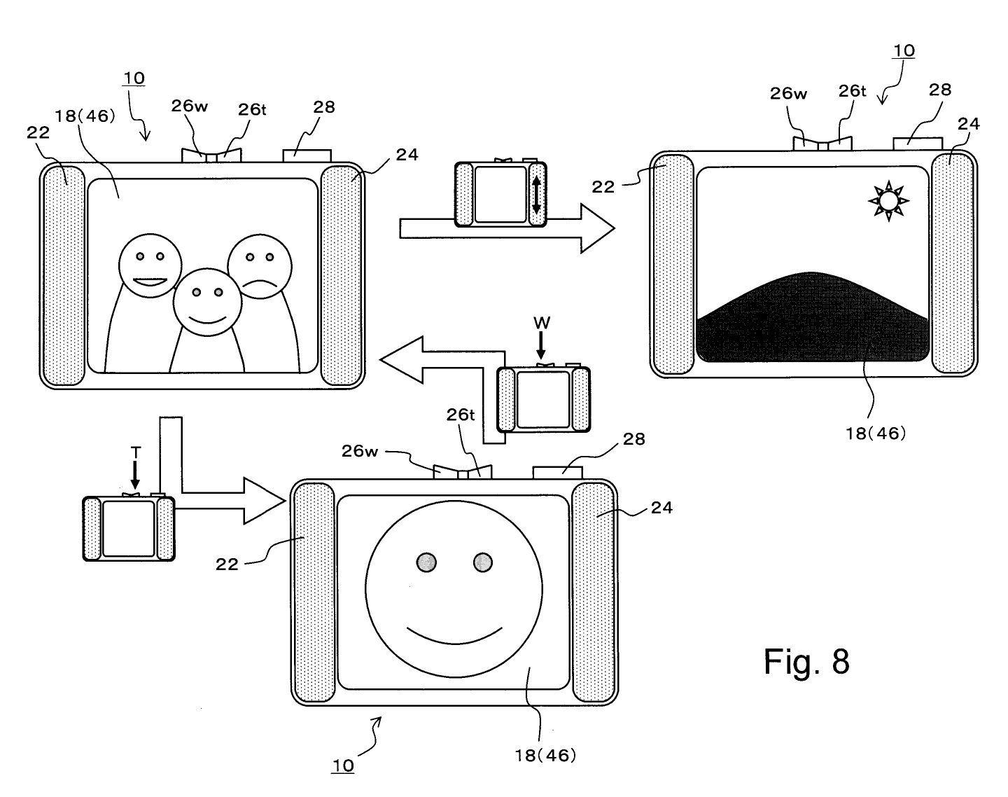

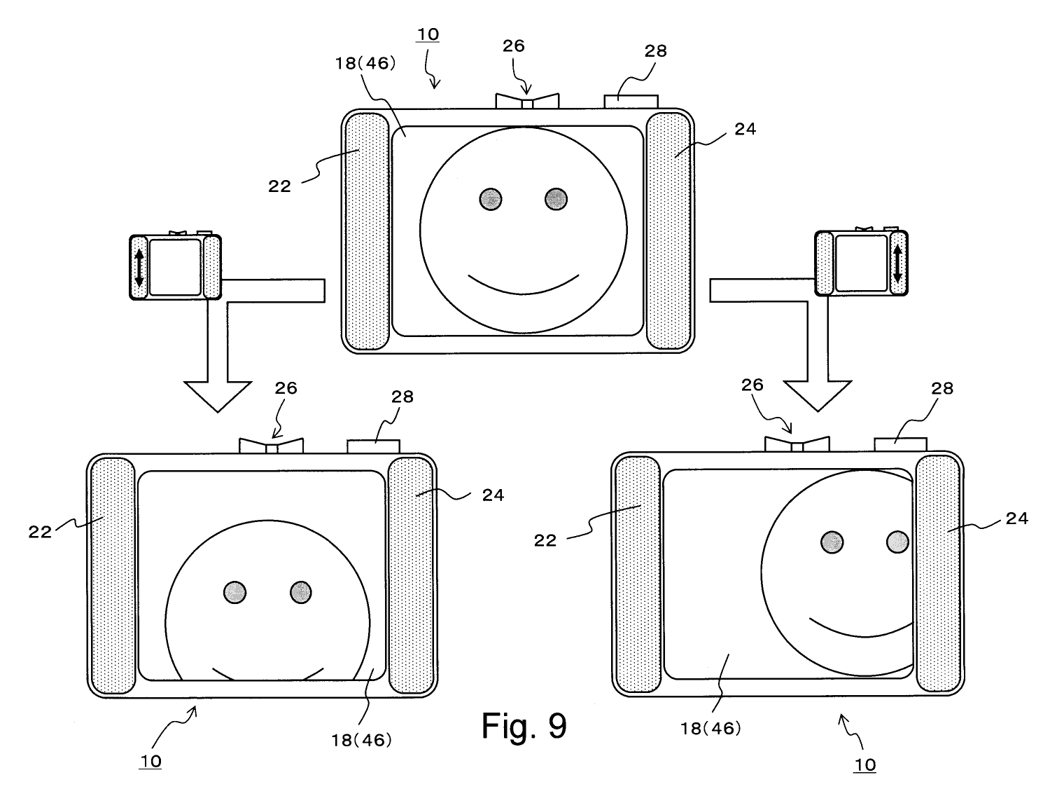

Furthermore, the user interface device according to the present embodiment enables a user to appropriately change the display state of a full-screen image by manipulating various operation elements. FIGS. 8 and 9 illustrate exemplary changes of the display state of a full-screen image. For example, a user can manipulate the zoom button 26 to change the display magnification of a full-screen image 46 as illustrated in FIG. 8. More specifically, if a user pushes the TELE switch 26t of the zoom button 26 in a full-screen display state, the controller 16 enlarges the display magnification of a recorded image according to the pushing time. On the contrary, if a user pushes the WIDE switch 26w of the zoom button 26 in a full-screen display state, the controller 16 decreases the display magnification of a recorded image according to the pushing time.

Furthermore, in a state where a full-screen image is displayed with a standard magnification (i.e., an exemplary state illustrated on the upper left of FIG. 8), if a vertical slide operation on the right-side touch strip 24 is detected, the controller 16 successively switches the displayed image 46 based on the orientation of the vertical slide operation. The recorded images 46 being successively displayed in this case are the recorded images 46 having the same shooting date.

If a vertical slide operation on the right-side touch strip 24 is detected in an enlarged display state of the recorded image 46 as illustrated in FIG. 9, the controller 16 pans the enlarged display of the recorded images 46 in the horizontal direction based on the orientation of the slide motion (refer to the lower right of FIG. 9). If a vertical slide operation on the left-side touch strip 22 is detected, the controller 16 scrolls the enlarged display of the recorded images 46 in the vertical direction based on the orientation of the slide motion (refer to the lower left of FIG. 9).

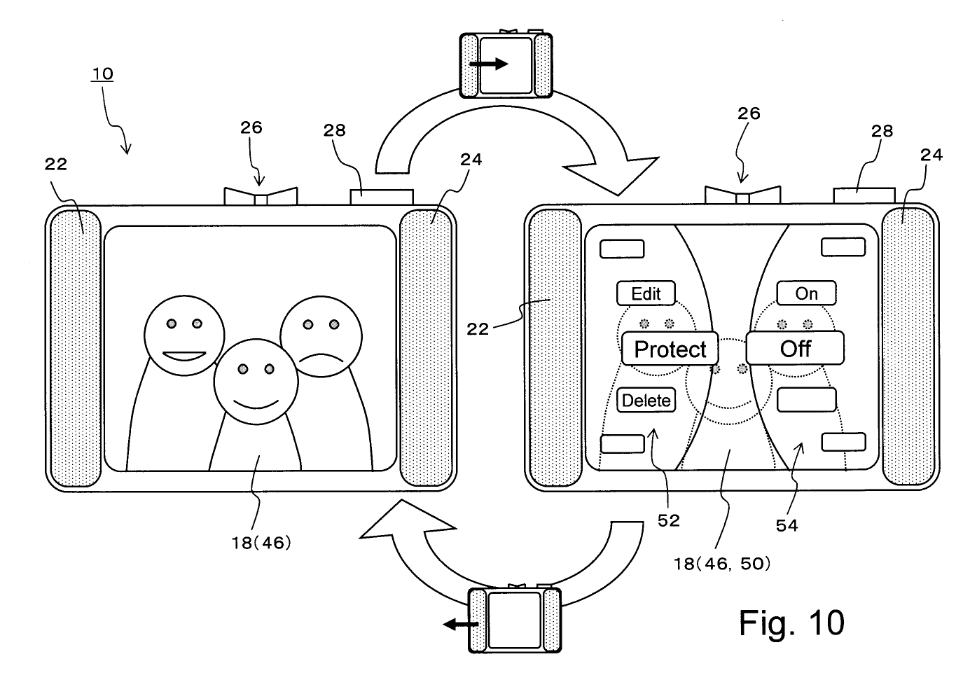

A user can change the operation mode to the image setting mode by performing a flip-in operation on the left-side touch strip 22 in a full-screen display state of a recorded image. FIG. 10 illustrates an exemplary display of an image and a setting screen in the image setting mode.

The image setting mode enables a user to perform various settings relating to a recorded image. If a flip-in operation on the left-side touch strip 22 is detected, the controller 16 displays an image setting screen 50 together with the presently displayed recorded image 46 as an introductory procedure for the image setting mode.

Similar to the menu setting screen 32, the image setting screen 50 includes a plurality of items which are classified into a hierarchical structure. More specifically, the controller 16 displays a plurality of upper hierarchical items 52 on the left side of the image setting screen 50, and the controller 16 displays a plurality of lower hierarchical items 54 corresponding to a presently selected upper hierarchical item 52 on the right side of the image setting screen 50. The displayed items 52 and 54 are items relating to the recorded images 46.

More specifically, the upper hierarchical items 52 of the image setting screen 50 include “Protect” which enables a user to protect determination relating to deletion or edit of the recorded image 46, “Edit” which enables a user to set edit contents of the recorded image 46, and “Delete” which enables a user to delete the recorded image 46.

When the image setting screen 50 is displayed, a user can select a desired item by manipulating two touch strips 22 and 24. More specifically, a user can perform a vertical slide operation on the left-side touch strip 22 to select an upper hierarchical item 52 and can perform a vertical slide operation on the right-side touch strip 24 to select a lower hierarchical item 54. Then, if a desired item is selected, the user can push the right-side touch strip 24. If a push operation on the right-side touch strip 24 is detected, the controller 16 newly stores the setting contents indicated by the presently selected item and returns the display mode to an ordinary full-screen display.

If a flip-out operation on the left-side touch strip 22 is detected in a state where the image setting screen 50 is displayed (i.e., in the image setting mode), the controller 16 terminates the operation of the image setting mode and returns the display mode to the ordinary full-screen display (refer to the left side of FIG. 10). Namely, the user interface device according to the present embodiment enables a user to switch the operation mode by executing a horizontal slide operation on the left-side touch strip 22.

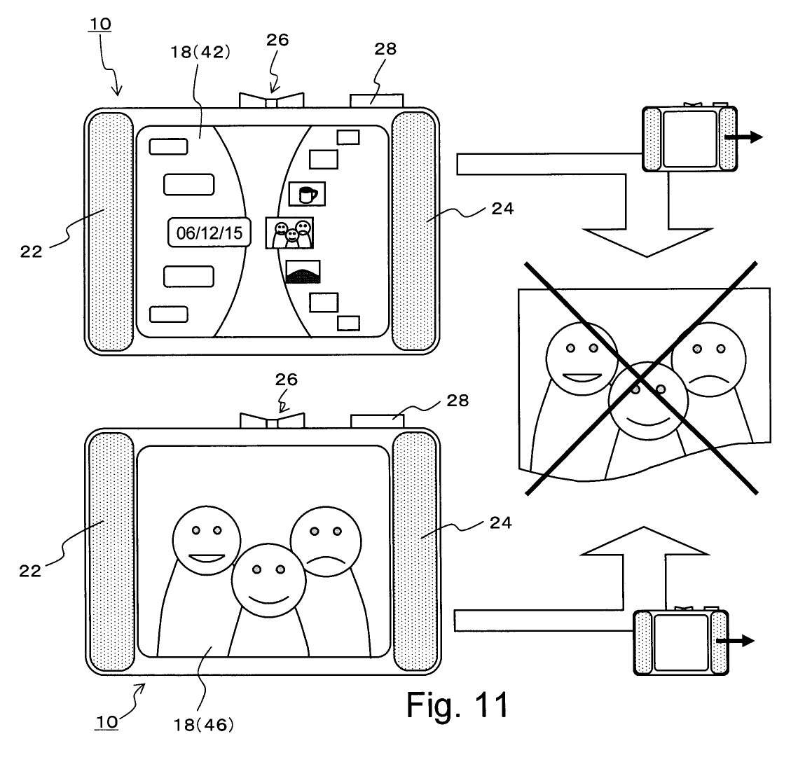

A user can delete the recorded image 46 by selecting the “Delete” function on the above-descried image setting screen. Meanwhile, the user interface device according to the present embodiment enables a user to easily delete the recorded image 46 by manipulating the right-side touch strip 24. FIG. 11 illustrates an exemplary deletion of the recorded image 46.

If a flip-out operation on the right-side touch strip 24 is detected in a state where the image selection screen 42 is displayed, or in a state where a full-screen image 46 is displayed, the controller 16 executes the processing for deleting a presently selected recorded image or a presently displayed full-screen image 46.

In other words, the controller 16 recognizes a horizontal slide operation on the right-side touch strip 24 as a triggering instruction for the image file delete processing.

As illustrated in FIG. 6, when the image selection screen 42 is displayed, the user interface device according to the present embodiment enables a user to perform a vertical slide operation on the right-side touch strip 24 to execute the processing for scrolling the recorded image 46 (more specifically, thumbnail images). Furthermore, as illustrated in FIG. 11, when the image selection screen 42 is displayed, the user interface device according to the present embodiment enables a user to perform a flip-out operation on the right-side touch strip 24 to execute the processing for deleting the recorded image 46. Furthermore, as illustrated in FIG. 7, when the image selection screen 42 is displayed, the user interface device according to the present embodiment enables a user to perform a push operation on the right-side touch strip 24 to execute a full-screen display of a selected recorded image 46. Namely, even if a user manipulates the same touch strip (right-side touch strip 24) at the same timing, the user interface device according to the present embodiment can distinguishably recognize the processing content based on the method of manipulation.

In other words, the user interface device according to the present embodiment can clearly discriminate the processing content based on the type of a manipulation or the direction of a slide operation even when a user manipulates the same touch strip (i.e., right-side touch strip 24) at the same timing. In this manner, the user interface device according to the present embodiment can clearly discriminate the processing content not only based on the direction of a slide operation but also based on the type of manipulation (e.g., a slide operation or a push operation).

As a result, the user interface device according to the present embodiment can recognize various instructions with a smaller number of operation elements. The present embodiment can reduce the total number of operation elements and can reduce the size of the digital camera 10. Compared to the pushing time and the number of pushing actions, it is easy for a user to discriminate the direction of a slide operation and the type of a manipulation (e.g., slide operation or push operation). Therefore, even if numerous functions are allocated to one operation element, a user can reduce erroneous operations.

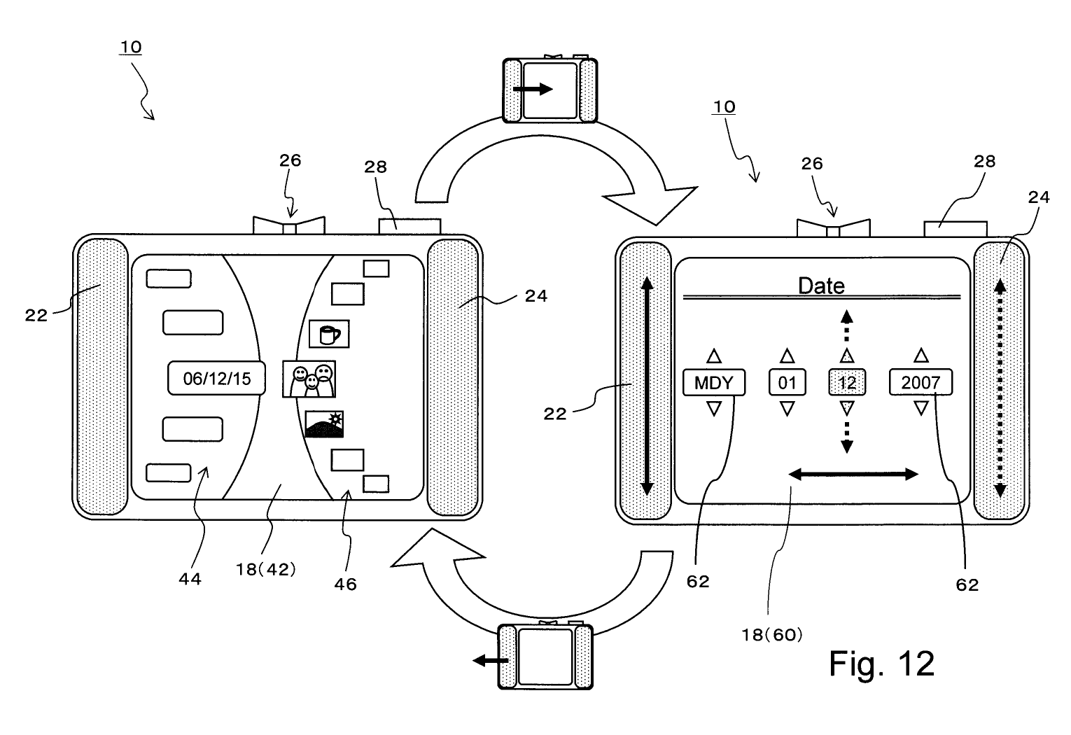

As another image selection method, a user can input a shooting date. FIG. 12 illustrates an exemplary image selection based on input of a shooting date. In a state where the above-described image selection screen 42 is displayed, if a flip-in operation on the left-side touch strip 22 is detected, the controller 16 displays a date input screen 60 on the display screen 18. The date input screen 60 includes some items 62 such as “year” and “month” as parameters representing the date. Among a plurality of items 62, a presently selected item 62 is displayed in a highlighted state. If a vertical slide operation on the left-side touch strip 22 is detected when the date input screen 60 is displayed, the controller 16 successively switches the position indicating a selected item 62. Furthermore, if a vertical slide operation on the right-side touch strip 24 is detected, the controller 16 successively increases or decreases the setting value of the presently selected item 62. Then, if a user finishes the setting of a desired date by performing a vertical slide operation on the touch strips 22 and 24, the user pushes the right-side touch strip 24. If the push operation on the right-side touch strip 24 is detected, the controller 16 causes the display screen 18 to display a full-screen image 46 captured on the date being presently set.

If a user wants to stop the date input mode, the user can perform a flip-out operation on the left-side touch strip 22 under the condition where the date input screen 60 is displayed. If the flip-out operation on the left-side touch strip 22 is detected, the controller 16 terminates the operation of the date input mode and displays the image selection screen on the display screen 18.

Finally, a user can input a character string to the UI device 14 in the following manner. In general, if a user wants to set a name for a file of images captured by the digital camera 10 or a name for an album storing a plurality of image files, the user inputs an arbitrary character string for setting a name. However, the digital camera is a portable electronic device which does not have sufficient space for the operation elements installed thereon. Therefore, a user cannot easily perform a character string input operation on the conventional digital camera.

In view of the above, the user interface device according to the present embodiment enables a user to easily perform a character string input operation using a virtual keyboard displayed on the display screen 18.

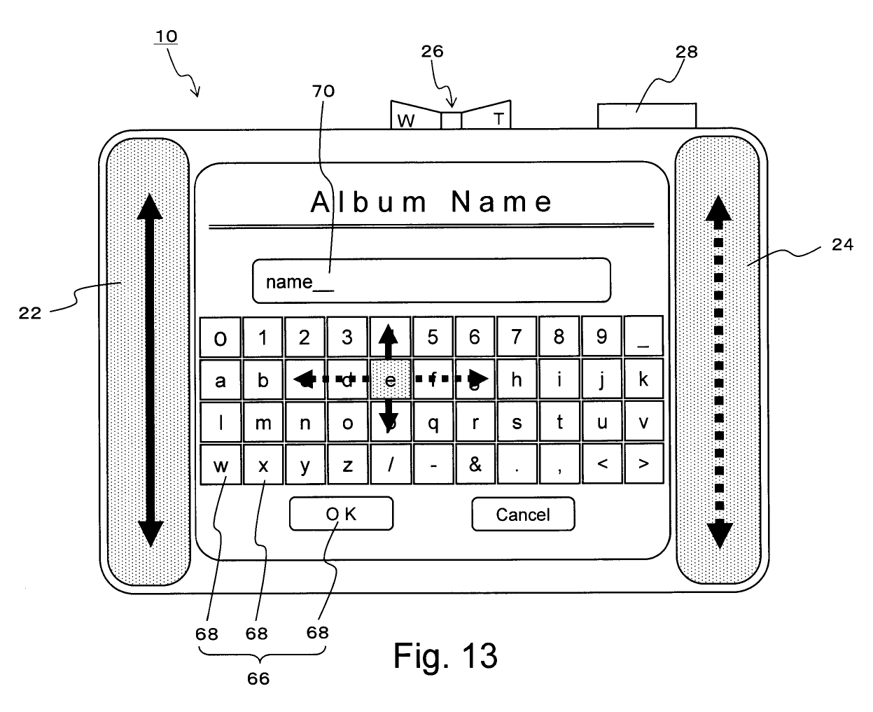

FIG. 13 illustrates an exemplary character string input operation. To enable a user to input an image file name or an album name, the controller 16 displays a character input screen 64 on the display screen 18. The character input screen 64, as illustrated in FIG. 13, includes a plurality of virtual keys 68 which constitute a virtual keyboard 66 and an input window 70 displayed on the upper side of the virtual keyboard 66.

The input window 70 displays input values having already been input by a user. According to the example illustrated in FIG. 13, a character string “name” is presently input by a user. Among the plurality of virtual keys 68 forming the virtual keyboard 66, a presently selected virtual key 68 is displayed in a highlighted state. A user can perform a vertical slide operation on two touch strips 22 and 24 to shift the position indicating a selected virtual key 68. If a vertical slide operation on the left-side touch strip 22 is detected, the controller 16 shifts the selected position vertically based on the orientation or distance of the vertical slide operation. If a vertical slide operation on the right-side touch strip 24 is detected, the controller 16 shifts the selected position horizontally based on the orientation or distance of the vertical slide operation.

In a state where a specific virtual key 68 is selected, if a flip-in operation on the left-side touch strip 22 or on the right-side touch strip 24 is detected, the controller 16 determines that a character indicated by the presently selected virtual key 68 is input.

Then, the controller 16 adds the selected character to the tail of a character string displayed in the input window 70. If a virtual key 68 designated by a flip-in operation of a user is “OK”, the controller 16 stores the presently input character string as an input name and stops the display of the character input screen 64. If a virtual key 68 designated by a flip-in operation of a user is “Cancel”, the controller 16 discards the presently input character string and stops the display of the character input screen 64.

On the other hand, if a flip-out operation on the left-side touch strip 22 or on the right-side touch strip 24 is detected in a situation where the character input screen 64 is displayed, the controller 16 deletes the last character having been input in a preceding input operation. More specifically, if a flip-out operation is detected after the character string “name” has been input as illustrated in FIG. 13, the controller 16 deletes the last character “e” in response to a flip-out operation on the left-side touch strip 22 or on the right-side touch strip 24.

As described above, the user interface device according to the present embodiment enables a user to change the selected position by performing a vertical slide operation on the touch strips 22 and 24 during a character string input operation. Furthermore, the user interface device according to the present embodiment enables a user to approve and delete the input value by performing a flip-in or flip-out operation on the touch strips 22 and 24. As a result, a user can easily input a character string even with a smaller number of operation elements.

Then, as will be apparent from the foregoing description, the user interface device according to the present embodiment recognizes a slide operation in the vertical direction on the touch strips 22 and 24 as a vector instruction that indicates scrolling of items and shifting of the position indicating a selected virtual key 68 based on the amount of movement.

Furthermore, the user interface device according to the present embodiment recognizes a slide operation in the horizontal direction on the touch strips 22 and 24 as a triggering instruction, such as a mode switching instruction, a new hierarchical item display instruction, a file deletion instruction, or a manipulation approval/cancellation instruction, which is not dependent on the amount of a slide operation.

In this manner, the user interface device according to the present embodiment can differentiate the function of each touch strip according to the direction of a slide operation. Thus, the present embodiment can reduce the total number of operation elements. A user can easily operate the operation elements without causing erroneous operations. As a result, the present embodiment can provide a digital camera which is compact in size and easy to manipulate.

Furthermore, the user interface device according to the present embodiment can change the function of respective touch strips 22 and 24 based on not only the direction of a slide operation but also the type of manipulation (i.e., a slide operation or a push operation) applied on the touch strips 22 and 24. In other words, the present embodiment can allocate numerous functions to one operation element. As a result, the present embodiment can reduce the number of operation elements and can reduce the size of the camera.

Furthermore, the user interface device according to the present embodiment enables a user to scroll the items displayed on the left side of the screen with the left-side touch strip 22 and enables a user to scroll the items displayed on the right side of the screen with the right-side touch strip 24. In other words, the present embodiment correlates the display position of an item with the position of a touch strip to be manipulated. As a result, a user can intuitively determine a touch strip to be manipulated and easily perform a manipulation.

Although the above-described embodiment has been described based on a digital camera, the present invention can be applied to any other portable electronic device, such as a portable game machine or a portable audio device, which cannot provide sufficient space for the operation elements being installed.

### PARTS LIST

10 digital camera
12 camera body function unit
14 user interface device
16 controller
18 display screen
20 operation element group
22 left-side touch strip
24 right-side touch strip
26 zoom button
26t TELE switch
26w WIDE switch
28 release button
30 pressure sensors
31 guide
32 menu setting screen
34 upper hierarchical items
36 lower hierarchical items
38 intermediate hierarchical items
40 arrow guide
42 image selection screen
44 shooting dates
46 recorded images
50 image setting screen
52 upper hierarchical items
54 lower hierarchical items
60 date input screen
62 items
64 character input screen
66 virtual keyboard
68 virtual keys
70 input window
100 hands

What is claimed is:

1. A user interface device equipped in a portable electronic device, which receives an instruction from a user and which presents information to a user, the user interface device comprising:
a display screen;
a slide detection unit which detects a slide operation applied by a user and which distinguishably detects a slide operation in a predetermined first direction and a slide operation in a second direction which is approximately perpendicular to the first direction; and
a controller which changes a content to be displayed on the display screen according to a slide operation detected by the slide detection unit; wherein
the controller recognizes a slide operation in the first direction detected by the slide detection unit as a vector instruction in which the amount of movement of the slide operation is heavily weighted, and recognizes a slide operation in the second direction as a triggering instruction in which the amount of movement of the slide operation is not heavily weighted.

2. The user interface device according to claim 1, wherein the controller recognizes the slide operation in the first direction as a shift instruction relating to at least one of item selection position, screen scrolling, and cursor position, based on a situation where the slide operation is detected by the slide detection unit.

3. The user interface device according to claim 1, wherein the controller recognizes the slide operation in the second direction as at least one of a mode switching instruction, a new hierarchical item display/non-display instruction, a selected file deletion instruction, and a manipulative instruction approval/cancellation instruction, based on a situation where the slide operation is detected by the slide detection unit.

4. The user interface device according to claim 1, wherein the first direction is a longitudinal direction of the slide detection unit and the second direction is a transverse direction of the slide detection unit.

5. The user interface device according to claim 1, further comprising:
a left slide detection unit which is a slide detection unit disposed outside of and on a left side of the display screen; and
a right slide detection unit which is a slide detection unit disposed outside of and on a right side of the display screen.

6. The user interface device according to claim 5, wherein when hierarchical items displayed on the right side of the display screen are different from hierarchical items displayed on the left side of the display screen, the controller recognizes the slide operation in the first direction detected by the left slide detection unit as a shift instruction relating to a position indicating a selected hierarchical item displayed on the left side of the display screen, and recognizes the slide operation in the second direction detected by the right slide detection unit as a shift instruction relating to a position indicating a selected hierarchical item displayed on the right side of the display screen.

7. The user interface device according to claim 1, wherein the slide detection unit is capable of detecting a push operation applied by a user in addition to the slide operation, and the controller determines whether an operation detected by the slide detection unit is a slide operation or a push operation and distinguishably recognizes a manipulative instruction depending on a determined operation type.

8. The user interface device according to claim 1, wherein the slide detection unit is capable of detecting a touch operation applied by a user in addition to the slide operation, and the controller determines whether an operation detected by the slide detection unit is a slide operation or a touch operation and distinguishably recognizes a manipulative instruction depending on a determined operation type.

9. The user interface device according to claim 1, wherein the controller displays a guide indicating processing contents executed by a manipulation of the slide detection unit, on a display screen, according to a manipulation situation.
